(19) United States
(12) Patent Application Publication
(10) Pub. No.: US 2013/0055361 A1
(43) Pub. Date: Feb. 28, 2013

(54) Mobile communications device security technique

(71) Applicant: Thomas Walsh, Somerset, NJ (US)

(72) Inventor: Thomas Walsh, Somerset, NJ (US)

(73) Assignee: Thomson Licensing

(21) Appl. No.: 13/199,293

(22) Filed: Aug. 25, 2011

(51) Int. Cl. H04L 29/06

(52) U.S. Cl. 726/5; 726/2

(57) ABSTRACT

The level of security associated with mobile communication device access is advantageously reduced while the mobile device resides at a location deemed to be “safe.” Determining whether the mobile communications device resides at a safe location depends on (a) location coordinates, and (b) frequency and duration of use of the mobile communication device at the location.

### TECHNICAL FIELD

This invention relates to a technique for controlling the level of security associated with verifying a mobile communication device, such as a portable computer, “smart phone,” personal data assistant (PDA) and the like.

### BACKGROUND ART

Advances in the art of wireless communication as well as the proliferation of wireless network service providers now enable mobile communication device users to gain network access from almost anywhere. Thus, mobile communication device users can access the same secure network services from remote locations just as they can from their home or office. However, some types of mobile communications devices have limited means for data entry. To achieve high security when accessing a secure server, a user must select a complex passwords having more than a few characters, which can prove difficult to enter on some mobile communications devices. Choosing no password, or a simple password, while simplifying data entry, reduces the level of security.

Thus a need exists for controlling mobile communication device security to take account of the difficulties in data entry, while still maintaining high security.

### BRIEF SUMMARY OF THE INVENTION

Briefly, in accordance with a preferred embodiment of the present principles, a method for controlling security for mobile communications device access commences by first determining if the mobile communications device currently resides at a location established to be safe in accordance with (a) location coordinates, and (b) frequency and duration of prior use of the mobile communication device at the location. If the location is established to be safe, then, the security requirements for the mobile communications device to obtain access can be adjusted while the mobile communications device resides at the safe location.

### BRIEF DESCRIPTION OF THE DRAWINGS

FIG. 1 depicts a block schematic diagram of a mobile communications device for accessing a network server using the security control technique of the present principles; and

FIG. 2 depicts in flow chart form the steps associated with user access of the application server of FIG. 1 in accordance with the security control technique of the present principles.

### DETAILED DISCUSSION

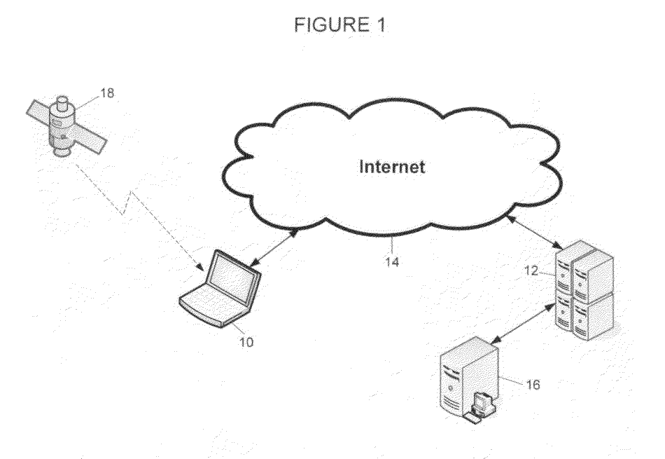

FIG. 1 depicts a block schematic diagram of a mobile communications device 10 obtaining a network service offered by an application server 12. In practice, the mobile communications device 10 accesses the applications server through one or more networks 14, such as, but not limited to the Internet. The nature of the network service sought by the mobile communications device 10 from the application server 12 will typically govern the level of security associated with accessing that service. For example, some applications might require no password or any other type of security in order for a user of the mobile communications device 10 to gain access. On the other hand, access to private information, such as access by a remote employee to a corporate database typically demands a level of security commensurate with the sensitive nature of the information.

For applications requiring user authentication, the application server 12 typically will depend on a security server 16 to perform the necessary verification of the mobile communications device 10. For ease of illustration the security server 16 appears in FIG. 1 separate from the applications server 12. However, those skilled in the art should appreciate that the functionality of the security server 16 could readily reside in the application server 12.

To access a sensitive application residing on the application server 12, a user of the mobile communications device 10 executes a security protocol which generally involves entering a password or personal identification number (PIN). Depending on the sensitivity of the application, the user might need to enter more than one password, as well enter the correct answer to one or more security-related questions prior to the security server 16 verifying the user to allow access to the applications server 12.

Depending on the form of the mobile communications device 10, data entry can prove difficult. In the preferred embodiment, mobile communications device 10 appears as a laptop computer with a full size keyboard. However, the mobile communications device 10 can readily take other forms such as a “smart phone” or personal data assistant (PDA) with a very limited keyboard which makes entry of lengthy data strings for verification impractical. Thus, the need to enter a lengthy data string for verification poses a dilemma. Reducing if not eliminating the need to enter a password or information for verification purposes makes access much easier. However, reducing the length of a password, or eliminating its use all together will jeopardize security, especially when a user seeks access from an un-trusted location, such as a public access point.

In accordance with a preferred embodiment of the present principles, the security protocol for controlling secure access, such as access to the application server 12, can be adjusted (e.g., reduced) depending on whether the mobile communications device 10 device currently resides at a location established to be safe in accordance with (a) location coordinates, and (b) frequency and duration of prior use of the mobile communication device at the location. In practice, the mobile communications device 10 of FIG. 1 typically includes a Global Positioning Satellite (GPS) receiver (not shown) for receiving GPS signals from orbiting satellites 18, only one of which appears in FIG. 1 for ease of illustration. Using received GPS satellite signals, the mobile communications device 10 can establish its location (e.g., the location longitude and latitude coordinates) and send such information to the security server 16 for use in practicing the security control technique of the present principles.

Using the location coordinates alone to determine whether the current location of the mobile communications device 10 is safe can prove problematic. A one-time visit by a user to a particular location generally will not establish the level of confidence necessary to deem such a location safe for purposes of reducing the security protocol associated with user verification. Therefore, the security control technique of the present principles not only takes account of the location at which the mobile communications device resides, but the frequency and duration of prior user visits to such a location. As discussed further, the security control technique of the present principles can also take into account whether the time at which the mobile communication seeks access coincides with past intervals of access.

To establish the frequency and duration of prior user visits to a given location, the security server 16 will monitor when and how long the mobile communications device 10 of FIG. 1 accesses the application server 12 from a given location. Using information indicative of when and how long the mobile communications device 10 of FIG. 1 accesses the application server 12 from a given location, the security server 16 can establish a histogram representative of frequency of access for a set period of time (e.g. a week, or a month). If the frequency of access from the particular location over the given period of time exceeds a threshold, then the security server 16 will deem the location “safe” and reduce the security protocol for verification. For increased safety, the reduction in security should, but need not necessarily, coincide with the same intervals the user had previously accessed during intervals the user has previously accessed the application server 12. Thus, if a user has repeatedly accessed the application server 12 during the hours of 9:00 AM to 6:00 PM from a particular location Monday through Friday, the location most probably corresponds to the user's work location so security can be reduced for this location during these hours.

The reduction in the security can take different forms. For example, the security server 16 of FIG. 1 could reduce security by eliminating the need for the user to enter security-related information in addition to a password. Also, the security server 16 could reduce security by allowing the user to enter a simple password (e.g., a password having few characters and/or no special characters (e.g., @, $, and * to name but few). Ultimately, the security server 16 could reduce security by totally eliminating the need for any password upon determining that the mobile communications device 10 currently resides at a location established to be safe.

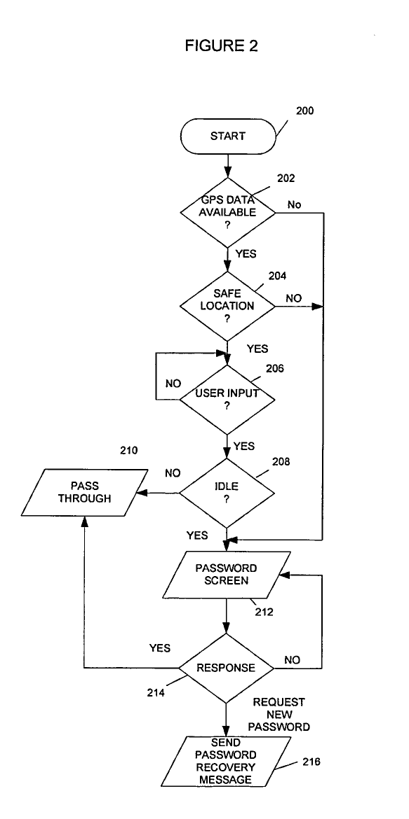

FIG. 2 depicts in flow chart form the steps associated with mobile communication device access in accordance with the security control technique of the present principles. The method starts upon execution of step 200 during which initialization occurs. Next execution of step 202 occurs during which the mobile communications device 10 of FIG. 1 checks the availability of GPS data from satellite 18 of FIG. 1. Assuming that GPS satellite data exists, and the mobile communications device 10 can establish its position and report the same to the security server 16 of FIG. 1, then step 204 of FIG. 2 undergoes execution to determine whether the mobile communications device 10 of FIG. 1 resides at a safe location. As discussed above, the safe location determination made during step 204 takes into account the (a) location coordinates, and (b) frequency and duration of prior use of the mobile communication device at the location. In addition, the safe location determination made during step 204 can also take into account whether the mobile communications device 10 seeks access from the location at the same time as during previous visits.

If the location is deemed safe during step 204, then step 206 undergoes execution to determine whether the user has entered data. If so, then step 208 undergoes execution. Otherwise, step 206 undergoes re-execution to continue to check for user data. During step 208, a check occurs whether the mobile communications device 10 has entered an idle or “sleep” state as will occur when no user activity exists for a given period of time. Assuming that the mobile communications device 10 of FIG. 1 currently remains active, then execution of step 210 occurs during which the security gets reduced, which in the present example, corresponds to elimination of the need to enter a password or personal identification number. In other words, the user's data “passes through” to the application server while the mobile communications device 10 resides at the safe location.

In the event that mobile communications device 10 has entered an idle state upon execution of step 208, then execution of step 212 occurs at which time the mobile communications device typically displays a password entry screen to prompt the user to enter a password. The rationale for prompting the user to enter a password upon emerging from the idle state is that circumstances could have changed since entering the idle state. For example, the mobile communications device 10 could have lost the GPS satellite signals and/or the user could have changed locations. Rather than execute step 212 and prompt for a password upon emergence of the mobile communications device 10 from the idle state during step 208, program execution could return to step 202. Note that execution of step 212 also occurs following a determination that no GPS data exists during step 202 or when the current location does not constitute a safe location upon execution of step 204.

Following execution of step 212, a check occurs during execution of step 214 whether the response of the user (e.g., the entered password or personal identification number) is valid. If so, execution of step 210 occurs as described previously. Otherwise, step 214 undergoes re-execution. During step 212, the user could enter a request for a new password. Upon the detecting the entry of such a request, a message requesting a new past word will be sent during step 216.

The security control technique of the present principles has been described with respect to access of a remote server (e.g., application server 12) by the mobile communications device 10, with the security server 16 determining whether the mobile communications resides at a location deemed safe. However, the mobile communications device itself can practice the security control technique of the present principles with regard to the user gaining access to the device at the outset of operation. For example, consider a mobile communications device 10 such as the laptop computer of FIG. 1 which requires the entry of a password or other type of security identifier prior to use. In accordance with the present principles, the mobile communications device 10 could reduce the security associated with initial access if the device resides at a “safe” location determined in accordance with (a) location coordinates, and (b) frequency and duration of prior use of the mobile communication device at the location. In other words, the functionality of the security server 16 could reside within the mobile communications device 10. Likewise, the mobile communications device 10 could reduce security while the device resides at a safe location for so long as the user accesses the device during the same intervals corresponding to past use form the same location.

To appreciate how the security control technique of the present principles benefits the user of the mobile communications device 10, consider the following situations. Assume that the user makes constant use of his or her mobile communications device 10 at work between the hours of 8:30 AM to 4:30 PM. If the user leaves the mobile communications device at work and someone else attempts to use the device after hours, the unauthorized user would be prompted to enter the password, assuming the safe location determination was conditioned on the use of the device at the safe location during the same interval as previous use of the device at that location. Thus, even though the mobile communications device resides at what was previously deemed a “safe” location, the location lost its status as being safe after passage of the time interval of expected use. If an unauthorized user attempted to replace the device SIM card, the mobile communications device 10 would still not operate with reduced security, assuming the device itself practiced the security control technique of the present principles.

The foregoing describes a technique for controlling the level of security associated with verifying a mobile communication device.

1. A method for controlling security for a mobile communications device, comprising the steps of:
determining if the mobile device currently resides at a location established to be safe in accordance with (a) location coordinates, and (b) frequency and duration of prior use of the mobile communication device at the location; and if the location is established to be safe, then
reducing security for the mobile communications access while the mobile communications device resides at the safe location.

2. The method according to claim 1 wherein the step of reducing security includes the reducing password length.

3. The method according to claim 1 wherein the step of reducing security includes eliminating password special characters.

4. The method according to claim 1 wherein the step of reducing security includes eliminating password(s).

5. The method according claim 1 wherein the determining step further includes checking whether access by the mobile communications device occurs during an interval corresponding to previous access at the location.

6. The method according to claim 1 wherein the determining step further includes checking whether the mobile communications device has entered an idle state, and if so, then prompting for password entry.

7. Apparatus for controlling security for a mobile communications device, comprising the steps of:
means for determining if the mobile device currently resides at a location established to be safe in accordance with (a) location coordinates, and (b) frequency and duration of prior use of the mobile communication device at the location; and if the location is established to be safe, then
means for reducing security for mobile communications device access while the mobile communications device resides at the safe location.

8. The apparatus of claim 7 method according to claim 1 wherein the means for reducing security reduces required password length.

9. The apparatus according to claim 7 wherein the means for reducing security eliminates required password special characters.

10. The apparatus according to claim 7 wherein the means for reducing security eliminates password(s).

11. The apparatus according claim 7 wherein the means for reducing security further includes means for checking whether mobile communications device access occurs during an interval corresponding to previous access at the location.

12. The apparatus according to claim 1 wherein the means for determining further checks whether the mobile communications device has entered an idle state, and if so, then prompts for password entry.
